(19) United States
(12) Patent Application Publication
(10) Pub. No.: US 2005/0157717 A1
(43) Pub. Date: Jul. 21, 2005

(54) Method and system for transmitting messages in an interconnection network

(76) Inventors: Cesar Douady, Orsay (FR); Philippe Boucard, Le Chesnay (FR)

Correspondence Address: MEYERTONS, HOOD, KIVLIN, KOWERT & GOETZEL, P.C., P.O. BOX 398, AUSTIN, TX, 78767-0398, US

(21) Appl. No.: 11/039,112

(22) Filed: Jan. 19, 2005

(30) Foreign Application Priority Data
Jan. 21, 2004 (FR) FR 0400554

(51) Int. Cl. H04L 12/56

(52) U.S. Cl. 370/389

(57) ABSTRACT

A method for transmitting messages in an interconnection network may include message initiating elements, message switching elements, and message destination elements. The messages may include a header and a content and are destined for processing elements capable of processing a data quantum of the content of a message independently of the other data quanta of the content of the message. The transmission of a first message is started by a switching agent, the header of the first message is stored, the transmission of the first message is interrupted when commanded and then the transmission of a second message is started whose content is the non-transmitted part of the content of the first message.

### BACKGROUND OF THE INVENTION

1. Field of the Invention

The present invention relates to a method and a system for transmitting messages in an interconnection network.

2. Description of the Relevant Art

Interconnection networks are means of transmitting messages between different electronic or data processing agents, or communicating entities. A transmission can be carried out without processing the message or with processing the message. The expression “message transmission” is used in all cases. The expression “processing a message” is understood to be, for example, an analysis of data contained in the message or a modification of message data.

A message is, of course, a series of information technology data, that is to say a series of bits or bytes arranged with specific semantics and representing a complete item of atomic information. Each message comprises a message header, which principally comprises the destination address of the message. Each message also comprises a content. A message is either a request transmitted by a message initiating agent, or it is a response by a destination agent or message target.

An ideal interconnection network, in terms of operational performance, would certainly be a totally interconnected network, that is to say a network in which each pair of agents is connected by a point-to-point link. This is unrealistic however as it becomes too complicated, in terms of hardware embodiment, as soon as there are more than a few dozen agents. It is therefore desirable that the interconnection network can provide all of the communications between agents with a limited number of links per agent.

In an interconnection network, an agent's input is connected to at most one message initiating agent, or to at most one message transmitting agent.

Interconnection networks comprise transmission devices or routers (or “switches”), an organization of the network providing the link between the routers and the other agents and a routing assembly which provides the circulation of messages within the organization of the network.

A router is an active agent of the interconnection network which receives on input messages coming from one or more agents and which directs or routes each of these messages to its destination agent or to another router respectively. This routing is carried out by means of the address of the destination agent of the message, or target agent, which is present in the header of the message to be routed.

The organization of a network constitutes the physical structure connecting the various nodes or connection points of an interconnection network.

The routing assembly manages the way in which a message is routed or directed from a source agent transmitting the message to the message's destination agent through routers by following a routing path.

The functioning of certain applications makes it necessary to retain the order of the messages circulating in the interconnection network. The message transmission protocol will, in the following description, be a protocol not allowing modification of the order of the messages transmitted by a message initiating agent. An agent can of course be a message initiating agent and a message destination agent.

The use of integrated networks in an on-chip system circuit connects elements which exchange messages by protocols that are asynchronous and therefore not predictable. Furthermore, it is necessary to have real time processing characteristics resulting in the interconnection network having a more deterministic behavior. These two concepts appear to be contradictory. One way of simultaneously taking account of these two constraints is to offer a quality of service, within the interconnection network which connects the different agents, for certain transactions. The term “transaction” means a series of messages forming a request transmitted by an initiating agent to a destination agent and the response to this request transmitted by the destination agent. The quality of service is defined by an algorithm which makes it possible, for a link between two agents, to choose a message to be transmitted from among a set of available messages.

There are solutions forming a compromise between, on the one hand, the transmission of short messages which favors a low latency and procures a high reactivity between the request sent by an initiating agent and the destination. Agent's response, and therefore a high quality of service, to the detriment of the effectiveness of the bandwidth, since as the messages are short, a large part of the bandwidth consists of headers of messages and not of contents of messages, and, on the other hand, the transmission of long messages, which favors an effective bandwidth, but a lower reactivity, and therefore a lower quality of service.

It is therefore a matter of obtaining the best possible bandwidth whilst having the best possible quality of service and an acceptable cost.

One solution is, for example, to give priority to the quality of service by favoring small transactions, formed by short messages, in order at any time to be able to interpose a high priority message between two transactions of lower priority already in the process of routing or transmission. The resources dedicated to the links therefore have excess capacity in order to guarantee the desired throughput, since the data representing headers of messages then take up a large proportion of the bandwidth. This solution is costly.

Another solution is to give priority to the bandwidth, by favoring large transmissions formed of long messages, in order to maximize the transfer of useful data, that is to say of contents of messages. This solution does not procure a good quality of service.

There are also solutions using sophisticated hardware elements for modifying the order of the messages in dedicated queues, in order to optimize accesses to one and the same target element. These solutions are of high cost.

### SUMMARY OF THE INVENTION

Thus, in the light of the above, an objective is to reconcile the best possible bandwidth and the best possible quality of service at an acceptable cost. Therefore, according to one aspect, a method for transmitting messages in an interconnection network including message initiating elements, message switching elements and message destination elements is proposed. The messages comprise a header and a content including data quanta and are destined for destination elements capable of processing a data quantum of the content of a message independently of the other data quanta of the content of the message. The transmission of a first message is started by a switching agent, the header of the first message is stored, the transmission of the first message is interrupted upon dynamic control and then the transmission of a second message is started whose content is the non-transmitted part of the content of the first message.

A data quantum is a predetermined quantity of data, for example 1, 2, or 4 bytes. It is possible to interrupt the transmission of a long message in order to carry out an action of higher priority, like transmitting messages of higher priority, and to subsequently resume the transmission of the interrupted message by storing only the header of that long message.

In an embodiment, the header of a message including size information indicating the size of the content of the message, the size information of the stored header of the first message, indicating the size of the non-transmitted content of the first message, is updated as the transmission of the data quanta of the first message progresses, in order to obtain a second message header.

In other words, information on the size of the content in the stored header of the first message is updated as the transmission of data quanta of the first message progresses.

Thus, the subsequently transmitted message, including the non-transmitted part of the content of the first message, indicates in its header the size of its content.

In an advantageous implementation, with the header of a message including address information indicating a start address for storing the content of the message, as the transmission of data quanta of the first message progresses, the address information of the stored header of the first message, indicating the start address for storing the content of the first message, is updated in order to obtain a second message header.

In other words, content storage start address information in the stored header of the first message is updated as the transmission of data quanta of the first message progresses.

Thus, the subsequently transmitted message, including the non-transmitted part of the first message, indicates in its header the address at which it is necessary to start storing its content.

In an implementation, after the transmission of the second message, there is assembled, on command, the transmitted part of the first message and the second message, arriving consecutively, whilst eliminating the header of the second message.

In other words, it is a matter of a first message having previously been cut as previously described into a transmitted part of the first message and a second message, having as its destination the same destination agent, which is the destination agent of the first message. The content of the second message is the non-transmitted part of the first message.

According to an aspect, there is also proposed a system for transmitting messages in an interconnection network including message initiating elements, message switching elements and message destination elements. The messages comprise a header and a content including data quanta. The messages are destined for destination elements capable of processing a data quantum of the content of a message independently of the other data quanta of the content of the message. The system comprises at least one switching element including at least one input equipped with a means of transmitting messages capable of starting the transmission of a first message, and at least one output equipped with a transmission decision means. The transmission means comprises a storage means capable of storing the header of the first message, and the decision means comprises a means of interrupting the transmission of the first message, and a means of starting the transmission of a second message whose content is the non-transmitted part of the content of the first message.

In an embodiment, with the header of a message including size information indicating the size of the content of the message, the message transmission means furthermore comprises a means of updating the size information of the header of the first message, indicating the size of the non-transmitted content of the first message, as the transmission of data quanta of the content of the first message progresses, in order to obtain a second message header, the header of the first message being stored in the storage means.

In an advantageous embodiment, the header of a message including address information indicating a start address for storing the content of the message, the message transmission means furthermore comprises a means for updating, as the transmission of data quanta of the content of the first message progresses, the address information of the header of the first message, indicating the start address for storing the content of the non-transmitted content of the first message, in order to obtain a second message header, the header of the first message being stored in the storage means.

In an embodiment, the system furthermore comprises another switching element situated after the switching element, between the initiating element and the destination element of the first message, the other switching element including at least one output including a decision means including a means of assembling the transmitted part of the first message and the second message, arriving consecutively, whilst eliminating the header of the second message.

### BRIEF DESCRIPTION OF THE DRAWINGS

Other objectives, characteristics, and advantages of the invention will appear on reading the following description, given by way of non-limiting example and with reference to the appended drawings in which:

FIG. 1 is a block diagram of an embodiment of a system according to one embodiment.

FIGS. 2 to 5 are logic diagrams illustrating the functioning of the system shown in FIG. 1.

FIG. 6 is a block diagram of an embodiment of a system according to another embodiment.

FIGS. 7 and 8 are logic diagrams illustrating the functioning of the system shown in FIG. 6.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents and alternatives falling within the spirit and scope of the present invention as defined by the appended claims.

### DETAILED DESCRIPTION OF EMBODIMENTS

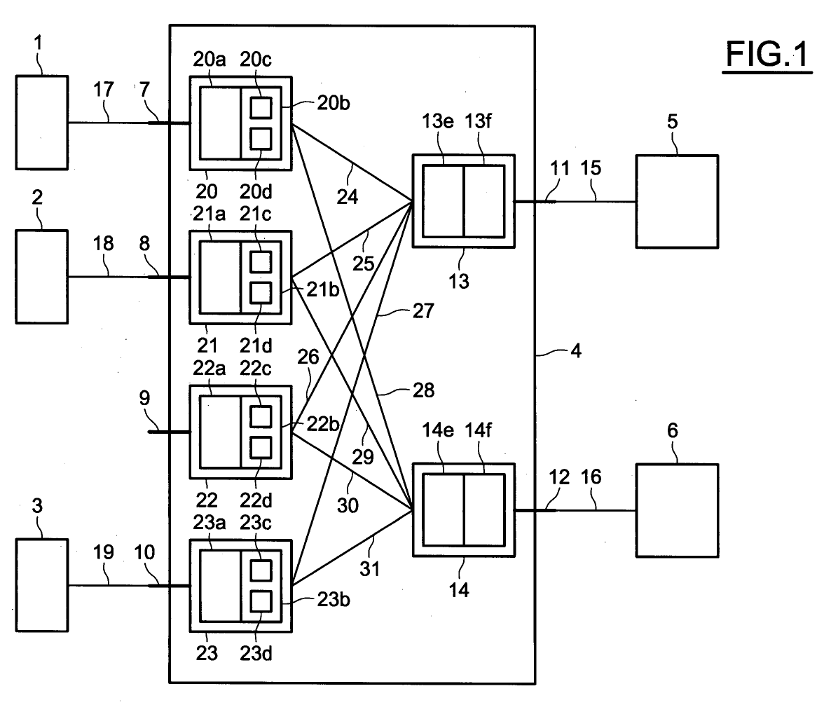

In FIG. 1, an interconnection system comprises three message initiating elements 1, 2, 3, a switching element or router 4, and two destination agents 5, 6. An initiating element is, for example, a central processing unit (CPU), or an external interface, and a destination element is, for example, a synchronous dynamic random access memory (SDRAM). The quantity of each of these element is not limited to that of the 5 described example.

In this example, the switching element 4 comprises four inputs 7, 8, 9, 10. Each input of an element of an interconnection system is connected to at most one other element of the interconnection system. The switching element 4 furthermore comprises two outputs 11 and 12. Each output 11, 12 of the switching element 4 respectively comprises a transmission decision module 13, 14 capable of deciding which message will be 5 transmitted on its output and if it is necessary to interrupt the transmission of a message which is in the process of being transmitted on its output. The outputs 11, 12 of the switching element 4 are respectively connected to an input of a destination element 5, 6 by connections 15, 16. The initiating elements 1, 2, 3, are respectively connected to the inputs 7, 8, 10 of the switching element 4 by the connections 17, 18, 19.

Each input 7, 8, 9, 10 of the switching element 4 respectively comprises a message transmission module 15 20, 21, 22, 23, each respectively including a storage module 20a, 21a, 22a, 23a, capable of storing a message header, and a header updating module 20b, 21b, 22b, 23b, capable of updating a header stored in the respective storage module 20a, 21a, 22a, 23a. Each header updating module 20b, 21b, 22b, 23b respectively comprises a size information updating module 20c, 21c, 22c, 23c indicating the size of the content of the message whose header is stored respectively in the storage module 20a, 21a, 22a, 23a. Each header updating module 20b, 21b, 22b, 23b respectively comprises an address information updating module 20d, 21d, 22d, 23d indicating a start of storage address for the content of the message whose header is respectively stored in the storage module 20a, 21a, 22a, 23a.

Each transmission decision module 13, 14 respectively comprises a module 13e, 14e to interrupt a first message and a module 13f, 14f to start the transmission of a second message whose content is the non-transmitted part of the content of the first message. The message transmission modules 20, 21, 22, 23 are respectively connected to the decision module 13 by connections 24, 25, 26, 27 and to the decision module 14 by connections 28, 29, 30, 31.

There will now be described an example of functioning of an aspect implemented by an embodiment shown in FIG. 1, in which the purpose of interrupting transmission of a long message is to allow a short message of higher priority to pass through.

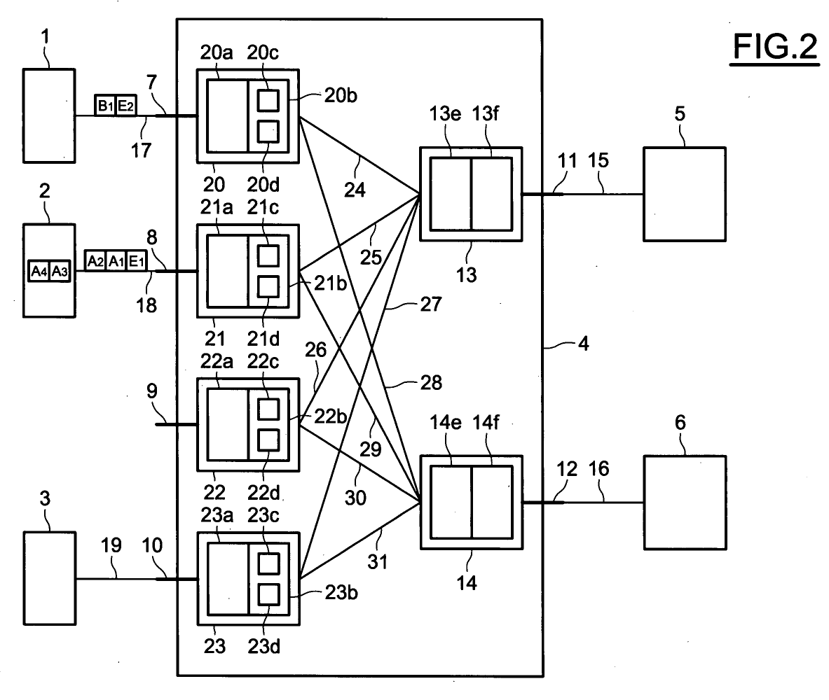

As shown in FIG. 2, the initiating element 2 has started to transmit to the input 8 of the switching element 4 a first message destined for the destination element 6. The first message is a long message, because it contains a large number of data quanta in its content, this number being 4 in this example. This first message comprises a header E₁ and a content including 4 successive data quanta A₁, A₂, A₃ and A₄. The initiating element 2 starts by sending the header E₁ and the data quanta A1, A2 through the connection 18. The initiating element 1 transmits a message to the input 7 of the switching element 4, this message being short and urgent and including a header E₂ and a data quantum B₁ destined for the destination element 6. Urgency is, for example, indicated by high priority information comprised in the header of the messages.

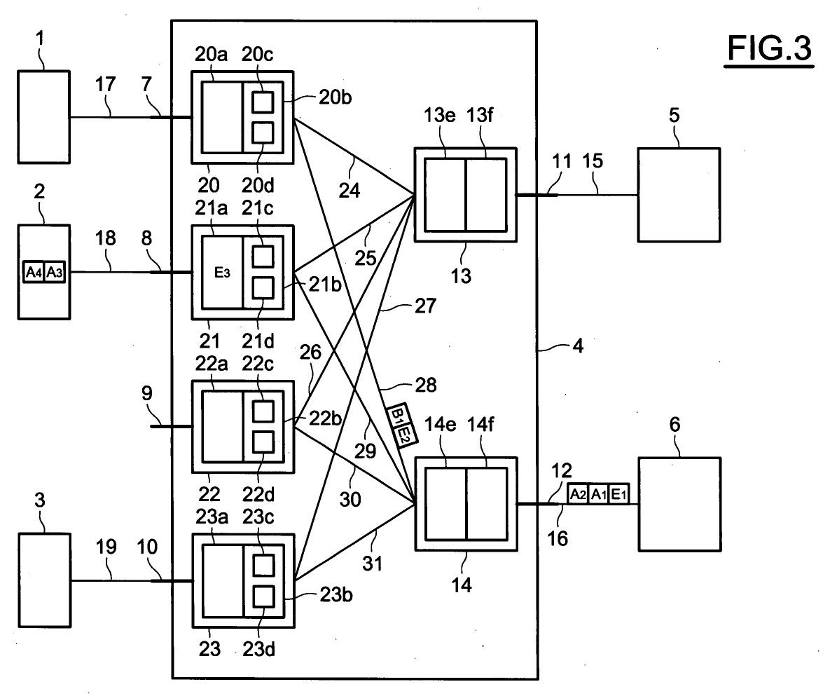

As shown in FIG. 3, the beginning of the first message is transmitted through the connection 29 and then through the connection 16 to the destination element 6. The beginning of the first message comprises, for example, the header E₁ and the data quanta A₁ and A₂.

If the first message expresses an instruction of the “read” (or “load”) type, then the header contains information indicating the address where data must be read and information indicating the size of the data expected in return. In this case, the header E₁ which is stored in the storage module 21 a is not updated since this is of no use. On the contrary, in the case of an instruction of the “write” (or “store”) type, that will be used in the rest of this description for the described messages, the header E₁ stored in the storage module 21a is updated by the module 21b.

The header E₁ of the first message comprises size information of the content of the first message which is updated by the module 21c and information of the address of the start of storage of the content of the first message which is updated by the module 21d, as the transmission of the data quanta of the content of the first message progresses. In this example, the size information has been decremented by the size of the transmitted data, that is to say by the size of two data quanta corresponding to the size of the two data quanta A₁, and A₂, and the start of storage address information has been incremented by the size of the transmitted data, that is to say by the size of two data quanta corresponding to the size of the two data quanta A₁, and A₂. The stored header E₁ is updated in the storage module, and it is then named E₃. At this time, the transmission interrupt module 14e of the decision module 14 interrupts the transmission of the first message, because it knows about the transmission of the short message and about the higher priority of this short message, like any switching element known to those skilled in the art. The decision module 14 then requests the initiating element 2, for example via a special connection connecting the switching element 4 and the initiating element 2, to interrupt the transmission of the first message. Only the beginning of the first message has been transmitted to the destination element 6, that is to say the header E₁ and the data quanta A₁ and A₂.

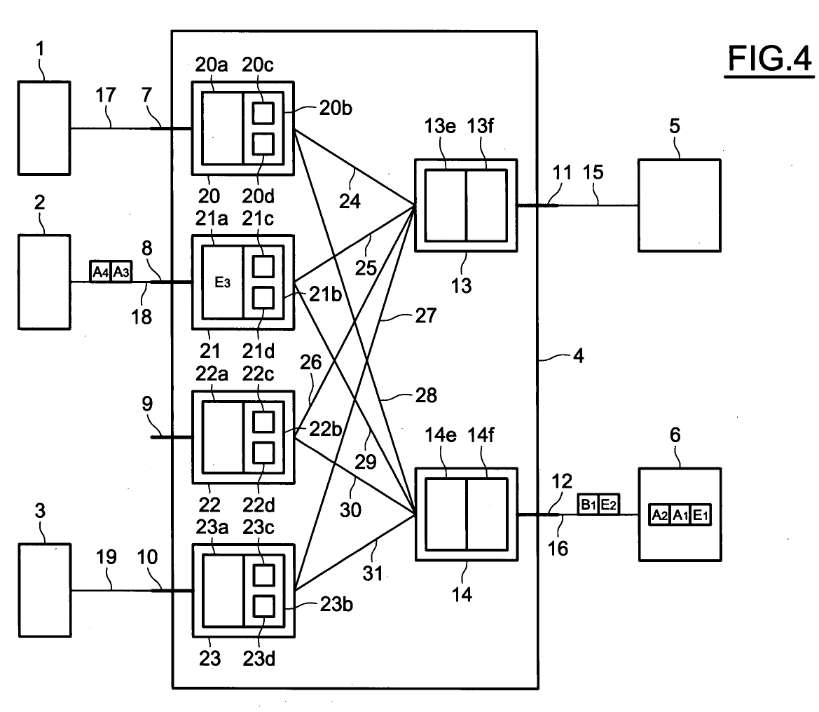

Subsequently, as shown in FIG. 4, the short message of higher priority having been transmitted to the destination element 6, the initiating element 2 transmits the end of the content of the first message, including the non-transmitted data quanta A₃ and A₄, to the destination element 6, through the input 8 of the switching element 4. The module 14f of the decision module 14 then starts the transmission of a second message having as its header the header E₃ stored in the storage module 21a and as its content the data quanta A₃ and A₄.

It has therefore been possible to stop, in order to resume subsequently, the transmission of a long message in order, for example, to transit a short message of higher priority. The quality of service of the system has therefore been improved without degrading the bandwidth and this has been done at low cost because only the header of messages transmitted by the switching elements has been stored, temporarily, which requires only a very small memory size for managing the contexts.

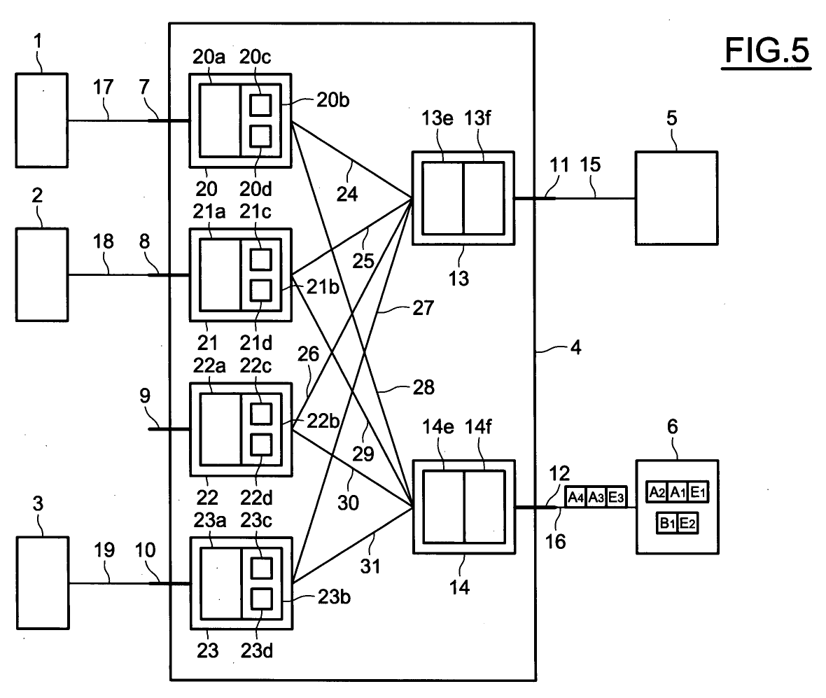

This second message is then transmitted to the destination element 6, as shown in FIG. 5.

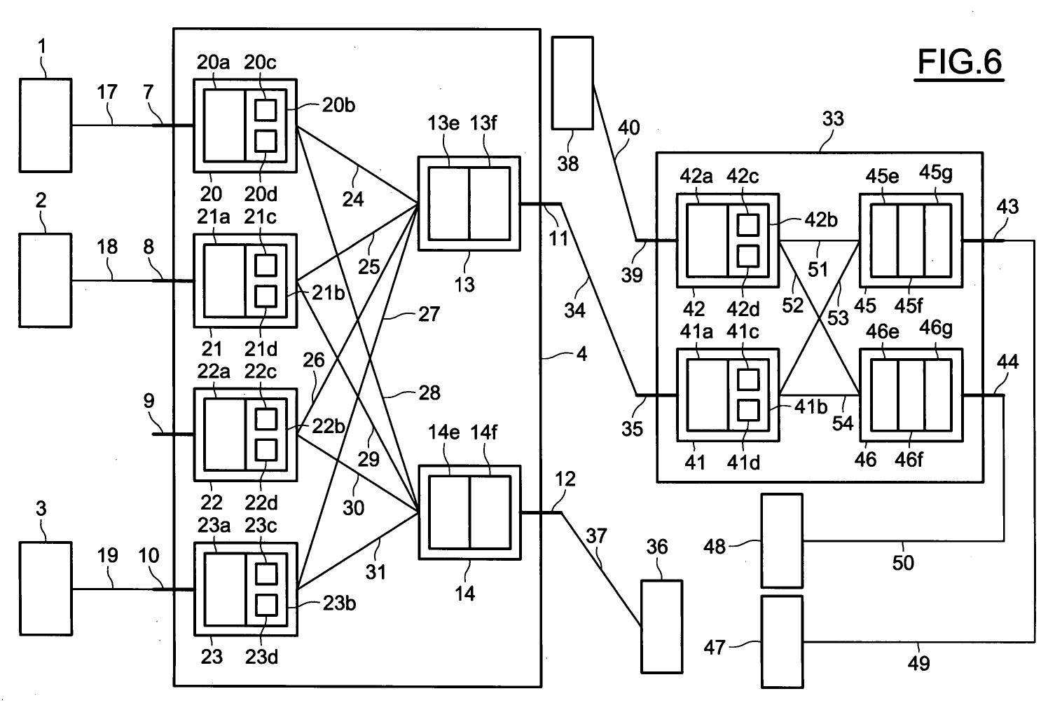

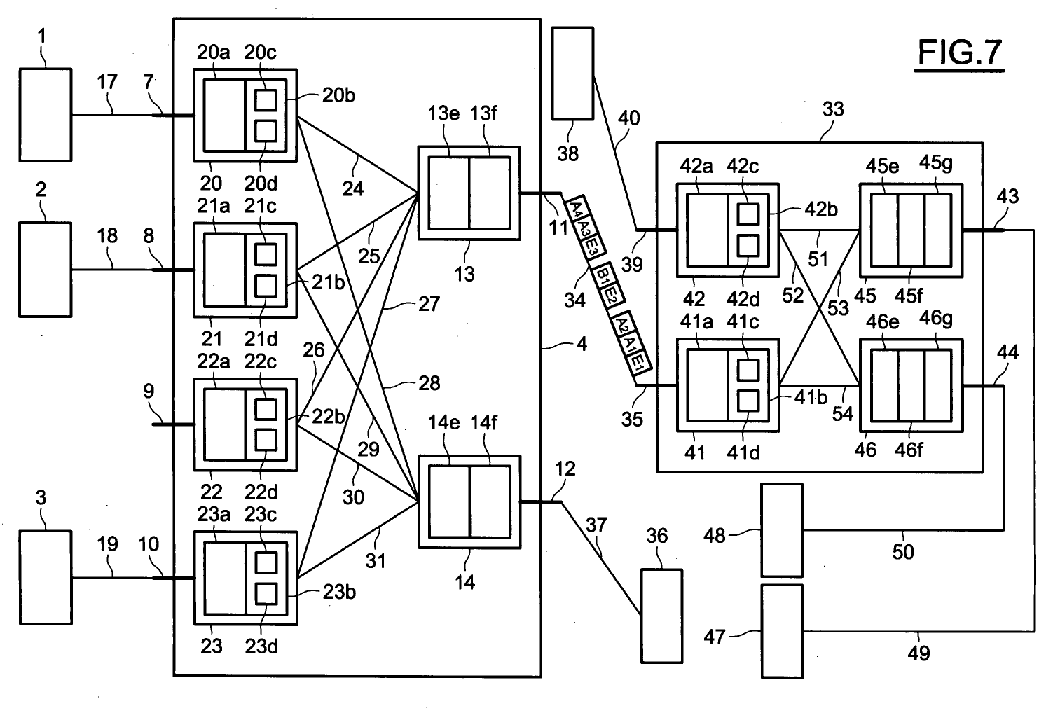

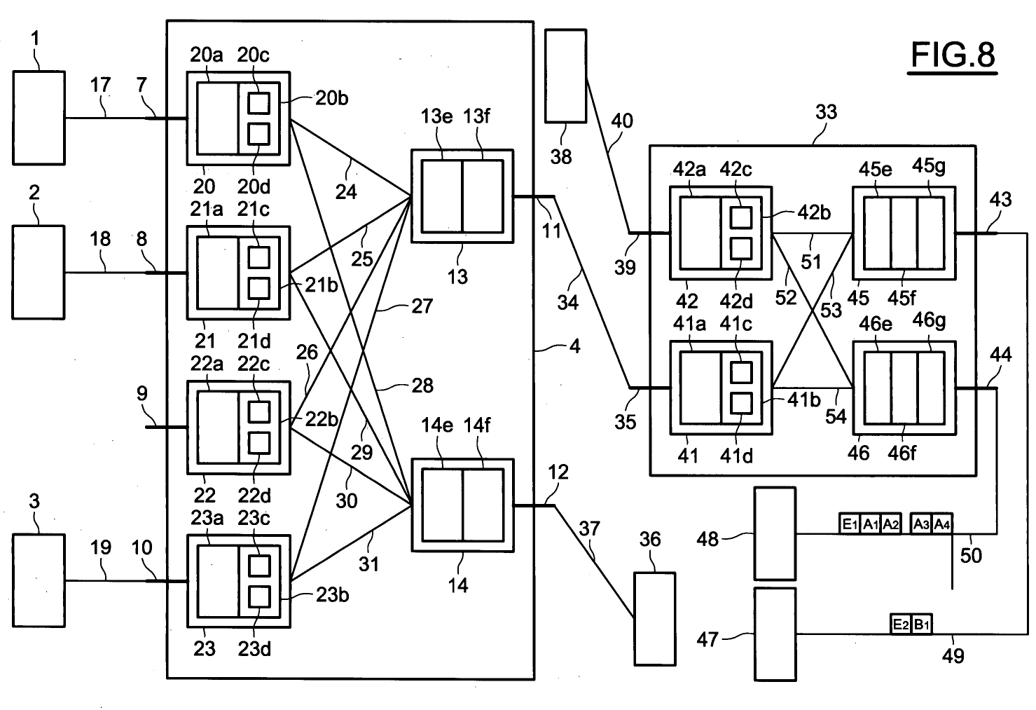

FIG. 6 shows an embodiment in which, when a long message has previously been cut into two shorter messages, as previously described, and when these two messages arrive consecutively on the input of a following switching element, then these two messages are assembled in such a way as to obtain the original long message.

The described system comprises a part that is in common with that of FIG. 1 and which will not be described again. The system furthermore comprises a switching element 33 connected to the switching element 4 by a connection 34 which connects the output 11 of the switching element 4 and an input 35 of the switching element 33. The system also comprises an additional destination element 36 connected to the output 12 of the switching element 4 by a connection 37, and an additional initiating element 38 connected to an input 39 of the switching element 33 by a connection 40.

The inputs 35, 39 of the switching element 33 respectively comprise a message transmission module 41, 42, each respectively including a storage module 41a, 42a capable of storing a message header, and a header updating module 41b, 42b capable of updating a header stored in the respective storage module 41a, 42a. Each header updating module 41b, 42b respectively comprises a module for updating size information 41c, 42c indicating the size of the content of the message whose header is stored respectively in the storage module 41a, 42a. Each header updating module 41b, 42b respectively comprises a module for updating address information 41d, 42d indicating an address for the start of storage of the content of the message whose header is respectively stored in the storage module 41a, 42a. The switching element 33 furthermore comprises two outputs 43, 44, each respectively including a transmission decision module 45, 46.

Each transmission decision module 45, 46 respectively comprises a module 45e, 46e to interrupt the transmission of a first message, and a module 45f, 46f to start the transmission of a second message whose content is the non-transmitted part of the content of the first message, like the switching element 4. Each decision module 45, 46 furthermore comprises, respectively, a module 45g, 46g for assembling two consecutive messages corresponding to a first message and a second message of an interrupted transmission of a long message as previously described. The outputs 43, 44 of the switching element 33 are respectively connected to two destination elements 47, 48 by connections 49, 50. The decision module 42 is connected to the decision modules 45, 46 by respective connections 51, 52 and the decision module 41 is connected to the decision modules 45, 46 by respective connections 53, 54.

It is assumed that an interruption of transmission of a first long message including a header E₁ and a content including four successive data quanta A₁, A₂, A₃, and A₄ has undergone a transmission interrupt as previously described. The switching element 4 has therefore transmitted the start of the first message, including the header E₁ and the data quanta A₁, A₂, and has then transmitted a short priority message including a header E₂ and a data quantum B₁, of higher priority, and finally it has transmitted a second message including a header E₃, corresponding to the updated header E₁, and the data quanta A₃, A₄ remaining to be transmitted. In this example, these messages are transmitted by the output 11 of the switching element 4 to the input 35 of the switching element 33. However, the short priority message is destined for the destination element 47 and the other messages are destined for the destination element 48.

The short priority message is then transmitted to the output 43 of the switching element 33, destined for the destination element 47, through the connection 49.

The decision module 46 therefore receives two consecutive messages corresponding to a prior transmission interrupt according to one aspect. In fact, it receives a message corresponding to the beginning of the long message, including the header E₁ and the data quanta A₁, A₂, followed by the message including the header E₃ and the data quanta A₃, A₄. The assembly module 46g detects that these two messages result from a preceding transmission interrupt since the stored header E1 updated by the method and the header E3 of the second message have the same destination, the same message content size information and the same start address for storing content information, for an instruction of the “write” type. The assembly module 46g then eliminates the header E3 and then transmits the header E1 followed by the data quanta A₁, A₂, followed by the data quanta A₃, A₄, which constitutes the first long message before its transmission interrupt. The destination element 48 will therefore receive the initial long message in a single message.

This also makes it possible to furthermore increase the efficiency of the bandwidth by not uselessly transmitting the header E₃.

At very low cost, the invention therefore makes it possible to have a high quality of service of the interconnection system, whilst having an excellent bandwidth.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A method for transmitting messages in an interconnection network comprising message initiating elements, message switching elements and message destination elements, the said messages comprising a header and a content comprising data quanta, the said messages being destined for destination elements capable of processing a data quantum of the content of a message independently of the other data quanta of the content of the message wherein:
the transmission of a first message is started by a switching agent;
the header of the first message is stored;
the transmission of the first message is interrupted upon dynamic control; and
the transmission of a second message is started whose content is the non-transmitted part of the content of the first message.

2. The method according to claim 1, wherein the header of a message comprising size information indicating the size of the content of the message, the size information of the stored header of the first message, indicating the size of the non-transmitted content of the first message, is updated as the transmission of the data quanta of the first message progresses, in order to obtain a second message header.

3. The method according to claim 2, wherein after the transmission of the second message, there is assembled, on command, the transmitted part of the said first message and the second message, arriving consecutively, whilst eliminating the header of the second message.

4. The method according to claim 2, wherein with the header of a message comprising address information indicating a start address for storing the content of the message, as the transmission of data quanta of the first message progresses, the address information of the stored header of the first message, indicating the start address for storing the content of the first message is updated in order to obtain a second message header.

5. The method according to claim 1, wherein with the header of a message comprising address information indicating a start address for storing the content of the message, as the transmission of data quanta of the first message progresses, the address information of the stored header of the first message, indicating the start address for storing the content of the first message is updated in order to obtain a second message header.

6. The method according to claim 5, wherein after the transmission of the second message, there is assembled, on command, the transmitted part of the said first message and the second message, arriving consecutively, whilst eliminating the header of the second message.

7. The method according to claim 1, wherein after the transmission of the second message, there is assembled, on command, the transmitted part of the said first message and the second message, arriving consecutively, whilst eliminating the header of the second message.

8. A system for transmitting messages in an interconnection network comprising message initiating elements, message switching elements and message destination elements, the said messages comprising a header and a content comprising data quanta, the said messages being destined for destination elements capable of processing a data quantum of the content of a message independently of the other data quanta of the content of the message, the system comprising at least one switching element comprising at least one input equipped with a means of transmitting messages capable of starting the transmission of a first message, and at least one output equipped with a transmission decision means, the said transmission means comprising a storage means capable of storing the header of the first message, and the said decision means comprising a means of interrupting the transmission of the first message, and a means of starting the transmission of a second message whose content is the non-transmitted part of the content of the first message.

9. The system according to claim 8, wherein the header of a message comprising address information indicating a start address for storing the content of the message, the said message transmission means further comprising a means for updating, as the transmission of data quanta of the content of the first message progresses, the address information of the header of the first message, indicating the start address for storing the content of the non-transmitted content of the first message, in order to obtain a second message header, the said header of the first message being stored in the said storage means.

10. The system according to claim 8, wherein with the header of a message comprising size information indicating the size of the content of the message, the said message transmission means further comprising a means of updating the size information of the header of the first message, indicating the size of the non-transmitted content of the first message, as the transmission of data quanta of the content of the first message progresses, in order to obtain a second message header, the said header of the first message being stored in the said storage means.

11. The system according to claim 10, further comprising another switching element situated after the said switching element, between the initiating element and the destination element of the first message, the said other switching element comprising at least one output comprising a decision means further comprising a means of assembling the transmitted part of the said first message and the second message, arriving consecutively, whilst eliminating the header of the second message.

12. The system according to claim 10, wherein the header of a message comprising address information indicating a start address for storing the content of the message, the said message transmission means further comprising a means for updating, as the transmission of data quanta of the content of the first message progresses, the address information of the header of the first message, indicating the start address for storing the content of the non-transmitted content of the first message, in order to obtain a second message header, the said header of the first message being stored in the said storage means.

13. The system according to claim 12, further comprising another switching element situated after the said switching element, between the initiating element and the destination element of the first message, the said other switching element comprising at least one output comprising a decision means further comprising a means of assembling the transmitted part of the said first message and the second message, arriving consecutively, whilst eliminating the header of the second message.

14. The system according to claim 8, further comprising another switching element situated after the said switching element, between the initiating element and the destination element of the first message, the said other switching element comprising at least one output comprising a decision means further comprising a means of assembling the transmitted part of the said first message and the second message, arriving consecutively, whilst eliminating the header of the second message.
